(19) United States
(12) Patent Application Publication
(10) Pub. No.: US 2025/0365475 A1
(43) Pub. Date: Nov. 27, 2025

(54) Method for managing the playback of multimedia content

(71) Applicant: Orange, Issy-les-Moulineaux (FR)

(72) Inventors: Hervé MARCHAND, CHATILLON CEDEX (FR); Olivier GASTE, CHATILLON CEDEX (FR)

(21) Appl. No.: 19/209,926

(22) Filed: May 16, 2025

(30) Foreign Application Priority Data
May 21, 2024 (FR) 2405142

(51) Int. Cl. H04N 21/472; H04N 21/262; H04N 21/6587

(52) U.S. Cl. CPC H04N 21/47217; H04N 21/2625; H04N 21/6587

(57) ABSTRACT

A method for managing the playback, by a playback device, of chunks of content which are accessible from content sources which are able to transmit chunks of the same content with a time lag. When the content from a first source is played back at a playback speed, referred to as a reference speed, receiving a command to rewind the content is followed by playing back chunks from a second source at a speed which is different from the reference speed, and by continuing to play back chunks originating from the first source when the chunks to be played back are available from the first source.

### CROSS REFERENCE TO RELATED APPLICATIONS

The present disclosure claims priority to French Patent Application No. FR2405142, filed on May 21, 2024, the disclosure of which is hereby expressly incorporated by reference herein in its entirety.

### TECHNICAL FIELD

The field of the present disclosure is that of digital multimedia content, namely digital audio and/or video content, also called audiovisual content.

An aspect of the disclosure relates most particularly to a method for managing playback of multimedia content.

In the example which will serve to illustrate an aspect of the disclosure, the content is content divided into chunks associated with several respective encoding rates which may be selected on requests sent from a multimedia stream playback device.

The content referred to here is accessible from several data sources (servers, for example); the sources have the particularity of transmitting content with a time lag; for example, one source makes available, to playback devices STB, content in real time (or live); another source, for example, transmits in unicast and may, on request, subsequently transmit the same content in a delayed manner, for example when a rewind is required.

A playback device refers to all devices which are able to receive multimedia streams, for example a set-top box, a mobile telephone, a tablet etc.

### BACKGROUND OF THE DISCLOSURE

It happens that sometimes the start of a TV programme (film, series, etc.) is missed. A function called “start over” or “restart”, or “catchup”, makes it possible to resume, at any moment, the programme being broadcast from its beginning or from a specific instant, for example in order to play back a particular scene. For example, if a film starts at 20:50 on a broadcast channel (a television channel) and a user switches to this television channel at 21:17, they may launch the start over function so that they may play back the content from the beginning.

Generally, real-time (also called “live”) content broadcasting is based on multicast technology. This technology makes it possible to save an enormous amount of bandwidth in the network of an operator managing the broadcasting, since the content is replicated as close as possible to the playback devices. On the other hand, when a playback device requires the use of the “play back from beginning” function, the requested content being accessed triggers an automatic switch from multicast technology to point-to-point content broadcast (unicast) technology which consumes much more bandwidth in the network of a telecommunications operator.

From the moment the user activates the “play back from beginning” function and a rewind has been executed, the playback device remains on a unicast stream and consumes only this unicast stream until the next channel change (switch) or action of returning to the live broadcast. However, using a unicast stream will lead to a bandwidth usage which may be enormous if the number of rewinds originating from several playback devices is executed at the same time, for example when the content concerns a major event.

One or more aspects of the present disclosure offer a solution which does not have the drawbacks of the prior art.

### SUMMARY

To this end, according to a first functional aspect, the subject of the disclosure is a method for managing the playback, by a playback device, of chunks of content which are accessible from content sources which are able to transmit chunks of the same content with a time lag, characterized in that, when the content is played back from a first source at a playback speed, referred to as the reference speed, receiving a command to rewind the content is followed by playing back chunks from a second source at a speed which is different from the reference speed, and by continuing to play back chunks originating from the first source when the chunks to be played back are available from the first source.

According to an aspect of the disclosure, the playback of the chunks originating from the second source is modified with respect to a reference speed; this modification of the speed, which may be an acceleration of the playback of chunks, makes it possible to catch up the stream originating from the first source and to continue the playback on the basis of the chunks originating from the first source. An aspect of the disclosure limits the use of the second source for playing back the content.

It should be noted that, in the case where the different speed referred to above concerns an acceleration of the playback, ideally the speed will be chosen so that the accelerated rendering is almost imperceptible to the human eye.

According to a first embodiment, playback at a different speed is carried out only if the rewind duration is less than a given duration, referred to as the first duration. Playback at a different speed is, in this case, conditional; the condition being that the duration of a rewind of the content does not exceed a given duration, so as to avoid a restart which will not be possible. For example, if the user rewinds content with a duration of 60 mins by 45 mins, it is useless to try to catch up the stream coming from the first server because this would involve much too great an accelerated playback speed, which would be akin to a fast forward of the content (with the symbol “>>” on most multimedia content players) rather than to accelerated playback. In other words, chunks originating from the second source (SU) are played back at a different speed if continuing to play back the content from the second source is possible. If the rewind is too great, it is understood that catching up the stream originating from the first source at a reasonable accelerated speed is almost impossible. For example, if the user rewinds content of 60 mins by 45 mins, it is useless to accelerate the playback and try to catch up the stream originating from the first source (for example, a live stream) since it would be necessary, in this case, to play back the content much too quickly; however, the aim pursued is a rendering at a slightly accelerated playback speed in order for the rendering to be understandable to a user.

It should be noted that an accelerated playback speed is to be distinguished from a fast forward; an accelerated playback speed making it possible to understand the rendered content.

According to a second embodiment, which may be implemented as an alternative or in addition to the previous embodiment, chunks are played back from the second source initially at the speed referred to as the reference speed and in that a different speed is used after a given duration, referred to as the second duration. According to this embodiment, the playback at a different speed, for example a speed which is greater than the reference speed, is performed after the second duration, which is comparable to a delay duration, expires. For example, if the user requires a 30-second rewind in order to view a sequence in the past, playback from the requested playback instant is carried out initially at a normal reference speed, and continues at a speed other than the reference speed as soon as the requested sequence is completed. Indeed, it can be considered that, if the user is interested in a specific sequence, they will appreciate a playback of the requested sequence at a normal speed.

According to one variant of the second embodiment, the second duration is equal to the duration of the rewind of the content. For example, if a 120-second rewind is requested, playback at the reference speed is carried out for 120 seconds, and then at a higher speed.

Other variants are, of course, conceivable; for example, the given duration may be chosen as a function of the rewind duration. The greater the rewind duration, the greater the given duration; conversely, the smaller the return duration, the smaller the given duration.

According to a third embodiment, which may be implemented as an alternative or in addition to the previous embodiments, the first source transmits the content in real time and the second source is able to transmit the content in a delayed manner. This fourth embodiment refers to a configuration of the system in which an aspect of the disclosure is of definite interest, namely a preferred first source for playback because of the advantages of multicast but which is not able to rewind the content; and a second source which makes it possible to rewind the content, and therefore to play back, in a delayed manner, the same content broadcast in multicast; such a second source is typically a unicast source.

According to a fourth embodiment, which may be implemented as an alternative or in addition to the previous embodiments, the first source is a transformation entity transforming a multicast stream received from a multicast server into a unicast stream. This embodiment refers to an optimal configuration of the method of an aspect of the disclosure in which the second source offers advantages in terms of bandwidth and image quality; storing chunks originating from a multicast server offers image quality during playback which is much higher than unicast mode.

According to a third embodiment, which may be implemented as an alternative or in addition to the previous embodiments, since the sources provide chunks with respective image qualities, said continuation of the playback of chunks originating from the first source is performed when the chunks to be played back are available from the first source and when the chunks concerned have an image quality which is higher than the image quality of the chunks originating from the second source. This embodiment makes it possible to render optimal image qualities during the continuation of the playback; playback continues either from the second source or from the first source according to whether the chunks concerned by playback have a higher or lower quality.

According to a hardware aspect, the disclosure relates to an entity for managing the playback, by a playback device, of chunks of content which are accessible from content sources which are able to transmit chunks of the same content with a time lag, the entity comprising a processor configured to, when the content is played back from a first source at a playback speed, referred to as the reference speed, after a command to rewind the content is received, play back the chunks from a second source at a speed which is different from the reference speed, the playback of the content continuing by playing back chunks originating from the first source when the chunks to be played back are available from the first source.

According to another hardware aspect, the disclosure relates to a playback device including a management entity as defined above.

According to another hardware aspect, the disclosure relates to a computer program which is able to be implemented on an entity as defined above, the program comprising code instructions which, when it is executed by a processor, perform the steps of the management method which are defined above.

According to another hardware aspect, the disclosure relates to a data medium on which at least one series of program code instructions for executing a method as defined above has been stored.

Such a storage medium may be any entity or device which is capable of storing the program. For example, the medium may comprise a storage means, such as a ROM, for example a CD-ROM or a microelectronic circuit ROM, or even a magnetic storage means, for example a USB key or a hard disk.

On the other hand, such a storage medium may be a transmissible medium such as an electrical or optical signal, which may be routed via an electrical or optical cable, by radio or by other means, so that the computer program which it contains may be executed remotely. The program according to an aspect of the disclosure may, in particular, be downloaded from a network, for example the Internet.

As an alternative, the storage medium may be an integrated circuit into which the program is incorporated, the circuit being adapted to execute or to be used in the execution of the abovementioned management method.

### BRIEF DESCRIPTION OF THE DRAWINGS

The disclosure will be better understood on reading the following description, which is given by way of example and with reference to the appended drawings, in which:

FIG. 1 depicts a computer system in which one example of an embodiment of the disclosure is illustrated.

FIG. 2 is a simplified block diagram of the hardware structure of the playback device;

FIG. 3 illustrates an embodiment of the method of the disclosure showing an execution of a command to rewind the content by virtue of the start over mode and the triggering of an accelerated playback of the content coming from the second source.

### DETAILED DESCRIPTION OF ILLUSTRATIVE ASPECTS OF THE DISCLOSURE

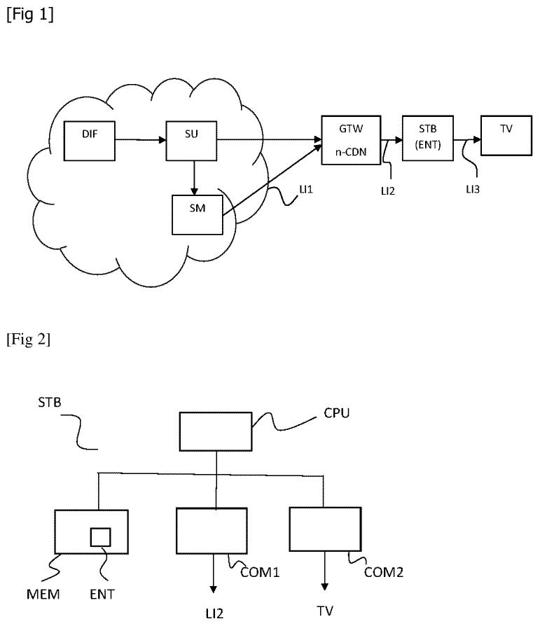

FIG. 1 depicts a computer system SYS in which a content distribution network (CDN), from which content is transmitted to client devices or content playback devices, is implemented.

In the present example, the system SYS comprises a single playback device STB. However, the disclosure applies to any number of playback devices.

The playback device STB is, for example, a digital television set-top box.

In the present example, the playback device STB is connected to a port of the rendering device TV; the playback device STB and the rendering device TV could also form one and the same device.

In the present example, the playback device STB is located in a local area network LAN managed by a residential gateway GTW.

The gateway GTW is able to communicate via a telecommunications network LI1 such as a wide area network WAN known to a person skilled in the art.

The CDN consists of servers networked in the wide area network.

The multimedia content referred to here is multimedia content corresponding to a television channel on which television programmes are broadcast.

Content may initially be available on a source DIF.

This source is connected to the content delivery network CDN, which forms, in a way, an overlay, to the telecommunications network, such as the Internet. The content delivery network CDN comprises several distinct content servers SU/SM which are able to transmit the same content to the playback device STB with a time lag.

In the present example, a first server is able to transmit content in unicast mode, referred to as the unicast server SU, and a second server SM is able to transmit the content in real time, for example in multicast.

The disclosure is not limited to this configuration but extends to any server which is capable of transmitting the same chunks with a time lag.

The configuration described above makes it possible, for example, to receive a stream of chunks in multicast, to request a rewind of the content and to continue to play back chunks originating from the unicast server starting from the desired chunk. It is well understood that there is a time lag between the chunks broadcast by the multicast source and the chunks received from the unicast server.

Typically, the chunks from the source DIF are transmitted to the first, unicast server and to a second, multicast server. The multicast server SM, or “multicaster”, may receive the chunks from the unicast server SU when a decision is taken to make multicast transmission possible. This decision may, for example, be taken by the first content source SU or by a supervision device, not depicted, which has knowledge of the number of playback devices wishing to receive given content.

The content CNT is made available in a given format. Such content CNT is, for example, content streamed via adaptive streaming. The MPEG-DASH (dynamic adaptive streaming over HTTP) standard is a format standard for audiovisual broadcast over the Internet; this standard is based on preparing various representations of variable quality and bit rate of the content, which are divided into chunks of short duration (of about a few seconds). Each of these chunks is made available individually by means of a protocol for exchange between the rendering terminal and the server providing multimedia content. The protocol mainly targeted is the HTTP protocol, but other protocols (for example FTP) may also be used. The organization of the chunks and the associated parameters are published in a manifest in XML format. The details of this streaming mode will not be entered into further since they are not of interest to the disclosure.

FIG. 2 depicts an architecture of a playback device STB. This device STB conventionally comprises memories MEM1 associated with a processor CPU1. The memories may be read-only memories (ROMs) or random-access memories (RAMs) or indeed flash memories.

The set-top box STB communicates with the gateway via an Ethernet module for wired local communication or via a Wi-Fi radio module for wireless local communication with the home gateway GTW. The module in question is referenced COM1 in FIG. 2. This link is referenced LI2 in FIG. 1.

The set-top box STB may transmit content to be rendered to the rendering device TV via a communication module COM2. This module COM2 is, for example, an HDMI link. This link is referenced LI3 in FIG. 1.

The set-top box STB comprises a streaming-mode download entity (not depicted) which is able to manage the downloading of chunks. The set-top box STB also comprises a management entity ENT, the function of which will be described below.

Furthermore, the playback device STB is equipped with an STRT (start over) function in order to replay content being broadcast.

The servers have an equivalent hardware structure. A server equipped with at least one processor and with memories for performing information processing. A server SRV communicates with the gateway GTW via a WAN.

The unicast server SU provides manifests to the playback device STB through the gateway GTW. On the basis of these manifests, the playback device STB may transmit requests for downloading a chunk of the resolution chosen from those which are available in the last manifest received.

The multicast server SM broadcasts an IPTV or equivalent continuous stream. The multicast server broadcasts the content in a broadcast tree, independently of the playback devices STB registered to obtain them. The nodes of the broadcast tree support the transmission up to the leaves which consist of the management entities, in particular the transformation entity which is present in the gateway GTW.

The system comprises a transformation entity referenced n-CDN which receives the multicast stream broadcast in real time (or live) and divides it into chunks; after the chunks have been produced, the transformation entity makes the chunks available to the playback device STB in unicast mode. The transformation entity n-CDN creates manifests accordingly. The playback device STB may thus access the manifests and the chunks of content which are described in these manifests by virtue of the stream transformation entity referenced n-CDN in the figures.

The location of the transformation entity n-CDN in the system is arbitrary. In the present example, this transformation entity is located in the gateway GTW.

From the point of view of the playback device STB, a transformation entity therefore forms the input of the content delivery network, CDN. Such a transformation entity may thus correspond to the terminology “nano CDN” or “n-CDN”, known to a person skilled in the art.

Ultimately, to simplify the disclosure, the playback device STB has two content sources, a first source n-CDN based on a multicast stream and a second source which is the unicast server SU; the first source n-CDN being connected to the multicast server and providing chunks in real time on the basis of a real-time data stream originating from the multicast server; the second source SU providing chunks in a delayed manner.

It is assumed that the stream of chunks is received at a given instant from the source n-CDN. This transmission mode is often preferred when such a stream is available because of the performance of multicast mode with respect to unicast mode in terms of bandwidth on the network and image quality.

It is assumed that, when chunks of the content are received from the source n-CDN, a user requests a rewind of the content. In this case, the management entity ENT triggers a request to receive the chunks from the unicast server. The playback device STB then receives the chunks from the unicast server SU from the desired replay instant.

Ultimately, the source n-CDN is a first content source, and the unicast server SU is a second content source; these two sources are able to transmit chunks with a time lag.

Also, generally, the chunks are played back at a given playback speed, referred to as the reference speed.

According to an aspect of the disclosure, when the content originating from the source n-CDN is played back, receiving a command to rewind the content is followed by playing back chunks originating from the source SU at a speed modified with respect to the reference speed; then, as soon as the chunks to be played back are available from the source n-CDN, playback resumes on the basis of the chunks originating from the source n-CND.

The modified speed, which may vary over time, is chosen so as to catch up the stream originating from the second source as quickly as possible without disturbing the user who is viewing the screen, the aim being to resume playing back the content on the basis of the chunks originating from the first source n-CDN as quickly as possible.

Preferably, the higher speed is chosen so that the difference between a rendering at a reference speed and a rendering at a higher speed is almost imperceptible to the human eye. Indeed, accelerated playback and a fast forward of the content must not be confused.

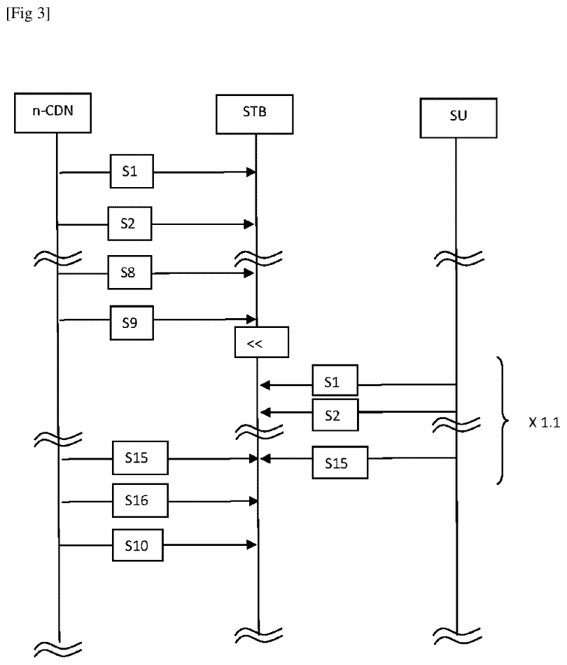

An embodiment will now be described with reference to FIG. 3.

This FIG. 3 illustrates a timing diagram for an example of an implementation of a method between a playback device STB, a source SU which is able to transmit the content in unicast mode and a source n-CDN receiving multicast streams from the multicast server SM; the source n-CDN will produce chunks of the content in real time and make them available.

In the embodiment, in order to simplify the disclosure, neither the transmission of the manifests nor the transmission of requests for access to the chunks will be described. It will be understood that each time a chunk is received is preceded by a request for access to the chunk. It will also be understood that manifests are transmitted by the two sources so that the playback devices STB may access the chunks.

In a first step, the playback device STB transmits successive requests for access to chunks S1-S9 to the transformation entity n-CDN and receives in return the chunks S1-S9 requested successively.

When a request is received, the transformation entity n-CDN subscribes to the desired multicast stream with the multicast server SM and receives in return a multicast data stream. The transformation entity n-CDN then transforms the continuous stream into encoded chunks and makes these chunks available.

It is assumed that, when chunks of the content are received from the transformation entity n-CDN, a user at a given instant requests a rewind (<<) of the content.

The playback device STB receives the rewind command (<<), the command including a particular chunk identifier from which playback is to be resumed. In the present example, a replay from the beginning, namely the first chunk S1, is requested.

In the present example, only the unicast server SU is capable of playing back content in a delayed manner. The playback device STB executes the command and requests the reception of the chunks starting from the chunk S1 from the unicast server SU.

According to an aspect of the disclosure, when receiving the content from the multicast server MC to the server SU, the playback device STB modifies the speed at which the chunks originating from the unicast server SU are played back.

It will be understood below that an acceleration of the playback requires chunks to be downloaded at a greater frequency and that a chunk will be played back more quickly. Since a video is a succession of images, accelerating playback will consist, for example, in displaying images of a chunk for less time than normal; or in extracting images from the chunk which are chosen judiciously so as to play back only a subset of images of a chunk and thus accelerate the playback of the chunk concerned while at the same time guaranteeing that the content is understood.

In the present example, the playback device STB continues to receive the chunks originating from the source n-CDN during the accelerated playback of the content from the unicast server SU.

During the accelerated playback of the content, a phase referenced (x1.1) in FIG. 3, the access requests are carried out at a higher frequency because the chunks are played back more quickly.

At a given instant, the chunk S15 is received both from the unicast server SU and from the source n-CDN. The playback device STB, and by implication the management entity ENT, prefers the chunk S15 originating from the source n-CDN for the reasons explained above. Upon reception, the playback device STB decodes the chunk S15 received from the source n-CDN and requests that the images of the chunk S15 be rendered; the playback device STB then continues the playback on the basis of chunks S16/S17/etc. originating from the source n-CDN.

It should be noted that the preceding example is based on a replay from the beginning. However, the disclosure also applies to a replay from another instant; for example, the replay of the chunks originating from the unicast server might have started at the third chunk S3.

It is therefore understood from the preceding text that, after the rewind command (symbol used on most devices “<<”) is executed, the playback device STB subscribes to the unicast stream and will attempt, throughout the accelerated playback on the basis of the chunks received from the unicast server, to hang on to the stream transmitted by the source n-CDN and by implication the multicast server SM with which the source n-CDN communicates. Thus, as seen above, when the playback of the live stream with a lag (consumed in unicast) results in chunks of the content originating from the source n-CDN; the playback device STB then stops receiving the unicast stream and uses the chunks originating from the source n-CDN.

### Taking a Concrete Example:

A programme begins at 21:00 and lasts 1 hr 45.

Suppose that the user accesses a live television programme at 21:05. The stream here is transmitted in multicast from the multicast server SM and transmitted to the gateway where the source n-CDN transforms the multicast stream into a unicast stream.

Suppose that the user activates the “start over” function and accesses the live broadcast with a lag of 5 minutes. After receiving a 5-minute rewind command, the playback device STB subscribes to the unicast stream originating from the unicast server SU in order to access the content with a lag. At this instant, according to one embodiment, the playback device STB accelerates the playback of the chunks originating from the unicast server SU.

After having viewed a few minutes of content in unicast, the time to catch up the chunks originating from the source n-CDN, the playback reaches a chunk in unicast which corresponds to the chunk to be played back originating from the source n-CDN. The playback device STB will then unsubscribe from the unicast stream with the unicast server SU and continue to play back the chunks originating from the source n-CDN, the latter subscribing to the multicast stream concerned.

Ultimately, of 1 hr 45 of programme, a few minutes of programme were received in unicast. The rest of the time, the chunks received are those created on the basis of the multicast stream. The bandwidth consumption in the network LI1 of the operator is thus optimized.

The embodiment described above may have variants.

According to a first variant, the management entity ENT obtains a datum which is representative of a possible catchup of the multicast stream. In this configuration, the management entity ENT decides whether or not to accelerate the playback of the chunks received in unicast from the unicast server SU. It is well understood here that an acceleration is of interest only if a catchup is possible and that not taking into account an impossibility leads to inappropriate processing which consumes processor resources.

According to another variant, the playback speed from the unicast source SU at an accelerated speed is delayed by a duration which is a function of the desired playback instant in a delayed manner included in the rewind command.

According to another variant, the delay duration is equal to the duration of the rewind of the content. For example, if a rewind of 5 minutes is desired, playback is carried out at the reference speed for 5 minutes and the playback speed is then accelerated in order to catch up the stream originating from the multicast server SM and resume playing back the chunks originating from the source n-CDN. Ultimately, the aim of an aspect of the disclosure is to limit the use of the unicast server SU; when a rewind which is relatively shallow in time is required, slightly accelerated playback makes it possible to return to the live stream as quickly as possible. By virtue of an aspect of the disclosure, the bandwidth saved on the network of the operator LI1 is great.

It is clear from the preceding text that the sources SU and n-CDN provide chunks associated with respective image qualities. According to one embodiment, the continuation of the playback, referred to above, of chunks originating from the first source n-CDN is performed only if the chunks to be played back are available from the first source n-CDN and if the chunks concerned have an image quality which is higher than the image quality of the chunks originating from the second source SU.

This embodiment ensures optimal rendering quality by choosing the source which provides chunks with the best quality. In other words, when, at an instant t, the chunks to be played back are available from both the unicast server and the multicast server, the accelerated playback having made it possible to catch up the multicast stream, the continuation of the playback from the multicast stream may be performed conditionally. A check is performed during which the entity compares the quality of the chunks originating from the multicast stream with the quality of the chunks originating from the unicast stream; if the quality of the chunks originating from the multicast stream is higher, then the playback is continued by playing back chunks of the multicast stream; there is, in this case, a transition from the playback of the unicast stream to the multicast stream. If, on the other hand, the quality of the chunks originating from the multicast stream is lower than the quality of the chunks of the unicast stream, then the playback is continued by continuing the playback on the basis of the chunks originating from the unicast stream. Ultimately, when the content from a first source (n-CDN) is played back at a playback speed, referred to as the reference speed, receiving a command to rewind the content is followed by playing back chunks from a second source SU at a speed which is different from the reference speed, and by continuing to play back chunks originating from the first source n-CDN when the chunks to be played back are available from the first source (n-CDN) and when the chunks concerned originating from the first source have a higher image quality than the image quality of the chunks originating from the second source (SU).

A reminder here that image quality is most often expressed in kb/s. By way of example, the most common qualities correspond to bit rates of 400 kb/s (kilobits per second), 800 kb/s, 1200 kb/s, 2100 kb/s, 3000 kb/s, etc. Let it be specified, finally, that, when the playback device STB has a bandwidth of 3000 kb/s, it may request the content at any bit rate which is lower than this limit, for example 2100 kb/s.

Let it be specified, finally, here that the term “entity” may correspond equally to a software component or to a hardware component or to a set of software and hardware components, a software component itself corresponding to one or more computer programs or subroutines or, more generally, to any element of a program which is able to implement a function or a set of functions as described for the modules concerned. In the same way, a hardware component corresponds to any element of a hardware assembly which is able to implement a function or a set of functions for the module concerned (integrated circuit, chip card, memory card etc.)

1. A management method comprising:
managing playback, by a playback device, of chunks of content which are accessible from content sources which are able to transmit chunks of a same content with a time lag, wherein the managing comprises:
when the content is played back from a first source at a playback speed, referred to as a reference speed, receiving a command to rewind the content is followed by playing back chunks from a second source at a speed which is different from the reference speed, and by continuing to play back chunks originating from the first source when the chunks to be played back are available from the first source.

2. The management method according to claim 1, wherein playback at a different speed is carried out only if a duration of the rewind is less than a given duration, referred to as a first duration.

3. The management method according to claim 1, wherein chunks are played back from the second source initially at the reference speed and a different speed is used after a given duration, called a second duration.

4. The management method according to claim 3, wherein the second duration is equal to the duration of the rewind of the content.

5. The management method according to claim 1, wherein the first source transmits the content in real time and the second source is able to transmit the content in a delayed manner.

6. The management method according to claim 1, wherein the first source is a transformation entity transforming a multicast stream received from a multicast server into a unicast stream.

7. The management method according to claim 1, wherein the first and second sources provide chunks with respective image qualities, and said continuation of the playback of chunks originating from the first source is performed when the chunks to be played back are available from the first source and when the chunks concerned have an image quality which is higher than an image quality of the chunks originating from the second source.

8. An entity for managing playback, by a playback device, of chunks of content which are accessible from content sources which are able to transmit chunks of a same content with a time lag, the entity comprising:
a processor configured to, when the content is played back from a first source at a playback speed, referred to as a reference speed, after a command to rewind the content is received, play back the chunks from a second source at a speed which is different from the reference speed, the playback of the content continuing by playing back chunks originating from the first source when the chunks to be played back are available from the first source.

9. The entity of claim 8, wherein the entity is comprised in the playback device.

10. A non-transitory computer readable data medium comprising a computer program stored thereon comprising code instructions which, when executed by a processor of a management entity, perform a management method comprising:
managing playback, by a playback device, of chunks of content which are accessible from content sources which are able to transmit chunks of a same content with a time lag, wherein the managing comprises:
when the content is played back from a first source at a playback speed, referred to as a reference speed, receiving a command to rewind the content is followed by playing back chunks from a second source at a speed which is different from the reference speed, and by continuing to play back chunks originating from the first source when the chunks to be played back are available from the first source.
